(19) United States
(12) Patent Application Publication
(10) Pub. No.: US 2012/0175966 A1
(43) Pub. Date: Jul. 12, 2012

(54) POWER SUPPLY SYSTEM

(75) Inventors: Takeshi NAKASHIMA, Osaka (JP); Takehito IKE, Osaka (JP); Ryuzo HAGIHARA, Osaka (JP)

(73) Assignee: SANYO ELECTRIC CO., LTD., OSAKA (JP)

(21) Appl. No.: 13/421,426

(22) Filed: Mar. 15, 2012

Related U.S. Application Data
(62) Division of application No. PCT/JP2011/071996, filed on Sep. 27, 2011.

(30) Foreign Application Priority Data
Oct. 15, 2010 (JP) 2010-233121
Oct. 15, 2010 (JP) 2010-233122

(51) Int. Cl. H02J 4/00

(52) U.S. Cl. 307/86

(57) ABSTRACT

In a power supply system with a storage battery assembly including storage battery pack groups, when electric power is supplied from at least one of the storage battery pack groups to a load connected to a parallel connection line, the storage battery pack group having the highest output voltage is selected from the storage battery pack groups capable of being commonly connected to the parallel connection line, and is first connected to the parallel connection line, and the highest output voltage of the output voltages of the storage battery pack groups connected to the parallel connection line is set as a reference voltage, and only the storage battery pack groups having an output voltage within a predetermined voltage range during discharging relative to the reference voltage are connected to the parallel connection line.

### CROSS REFERENCE TO RELATED APPLICATION

The present application is a continuation application of International Application No. PCT/JP2011/071996, filed Sep. 27, 2011, the entire contents of which are incorporated herein by reference and priority to which is hereby claimed. The PCT/JP2011/071996 application claimed the benefit of the date of the earlier filed Japanese Patent Application Nos. 2010-233121, filed Oct. 15, 2010, and 2010-233122, filed Oct. 15, 2010, the entire contents of which are incorporated herein by reference, and priority to which is hereby claimed.

### TECHNICAL FIELD

The present invention relates to a power supply system including a storage battery.

### BACKGROUND ART

A power supply system in which a commercial power supply and a storage battery are combined with each other has begun to be used for effective utilization of electric power. That is, in response to a temporal fluctuation in load, electric power discharged from a storage battery, in addition to electric power from a commercial power supply, is supplied to a load when the load is high, and the storage battery is charged by the commercial power supply when the load is low. Consequently, electric power delivered from a commercial power supply can be temporally averaged. Also, power supply systems are combined with photovoltaic power generating systems and fuel cell systems that have recently shown rapid progress.

### SUMMARY OF INVENTION

### Technical Problem

In such a power supply system, when a plurality of units of storage batteries connected to each other in parallel charge or discharge, electric power is then exchanged among the storage batteries if output voltages of the storage batteries differ from each other. Then, when there are large potential differences among the output voltages of the storage batteries, a large amount of charging or discharging current flows from/to the storage batteries between which a large potential difference is present, and their lives may be thus shortened.

### Solution to Problem

The present invention provides a power supply system with a storage battery assembly including a plurality of storage battery pack groups connected to a parallel connection line via respective selecting switches, each storage battery pack group including at least one storage battery cell, in which, when electric power is supplied from at least one of the storage battery pack groups to a load connected to the parallel connection line, the storage battery pack group having the highest output voltage is selected from the storage battery pack groups included in the storage battery assembly and capable of being commonly connected to the parallel connection line, and is first connected to the parallel connection line, and the highest output voltage of the output voltages of the storage battery pack groups connected to the parallel connection line is set as a reference voltage, and only the storage battery pack groups having an output voltage within a predetermined voltage range during discharging relative to the reference voltage are connected to the parallel connection line.

The present invention provides a power supply system including a storage battery assembly having a plurality of storage battery pack groups connected to a parallel connection line via respective selecting switches, each storage battery pack group including at least one storage battery cell, and a power converter having a bidirectional DC/AC conversion circuit or a bidirectional voltage conversion circuit and connected to a plurality of storage battery units included in the storage battery assembly via respective unit switches, in which the storage battery pack group having the highest output voltage is selected from the storage battery pack groups included in the storage battery unit first connected to the power converter by closing the unit switch, and is first connected to the parallel connection line, and the highest output voltage of the output voltages of the storage battery pack groups connected to the parallel connection line is set as a reference voltage, and only the storage battery pack groups having an output voltage within a predetermined voltage range during discharging relative to the reference voltage are connected to the parallel connection line.

The present invention provides a power supply system with a storage battery assembly including a plurality of storage battery pack groups connected to a parallel connection line via respective selecting switches, each storage battery pack group having at least one storage battery cell, in which, when at least one of the storage battery pack groups is charged via the parallel connection line, the storage battery pack group having the lowest output voltage is selected from the storage battery pack groups included in the storage battery assembly and capable of being commonly connected to the parallel connection line, and is first connected to the parallel connection line, and the lowest output voltage of the output voltages of the storage battery pack groups connected to the parallel connection line is set as a reference voltage, and only the storage battery pack groups having an output voltage within a predetermined voltage range during charging relative to the reference voltage are connected to the parallel connection line.

The present invention provides a power supply system including a storage battery assembly having a plurality of storage battery pack groups connected to a parallel connection line via respective selecting switches, each storage battery pack group having at least one storage battery cell, and a power converter having a bidirectional DC/AC conversion circuit or a bidirectional voltage conversion circuit, and connected to a plurality of storage battery units included in the storage battery assembly via respective unit switches, in which the storage battery pack group having the lowest output voltage is selected from the storage battery pack groups included in the storage battery unit first connected to the power converter by closing the unit switches, and is first connected to the parallel connection line, and the lowest output voltage of the output voltages of the storage battery pack groups connected to the parallel connection line is set as a reference voltage, and only the storage battery pack groups having an output voltage within a predetermined voltage range during charging relative to the reference voltage are connected to the parallel connection line.

### Advantageous Effects of Invention

The present invention can provide a power supply system capable of preventing performance degradation caused by charging or discharging of storage batteries.

### BRIEF DESCRIPTION OF THE DRAWINGS

FIG. 1 shows an entire configuration of a power supply system in an embodiment according to the present invention.

FIG. 2 shows a configuration of the power supply system in the embodiment according to the present invention.

FIG. 3 shows a configuration of a storage battery unit in the embodiment according to the present invention.

FIG. 4 shows a configuration of a storage battery unit in a first embodiment.

FIG. 5 shows a flowchart for illustrating a discharging method in the first embodiment.

FIG. 6 illustrates the discharging method in the first embodiment.

FIG. 7 shows another example of a configuration of a storage battery unit in the first embodiment.

FIG. 8 shows a flowchart for illustrating a charging method in the first embodiment.

FIG. 9 illustrates the charging method in the first embodiment.

FIG. 10 shows a configuration of a storage battery unit in a second embodiment.

FIG. 11 illustrates a discharging method in the second embodiment.

FIG. 12 illustrates a charging method in the second embodiment.

FIG. 13 shows another configuration of each of switches.

FIG. 14 shows another example of a configuration of a storage battery unit.

### DESCRIPTION OF EMBODIMENTS

### First Embodiment

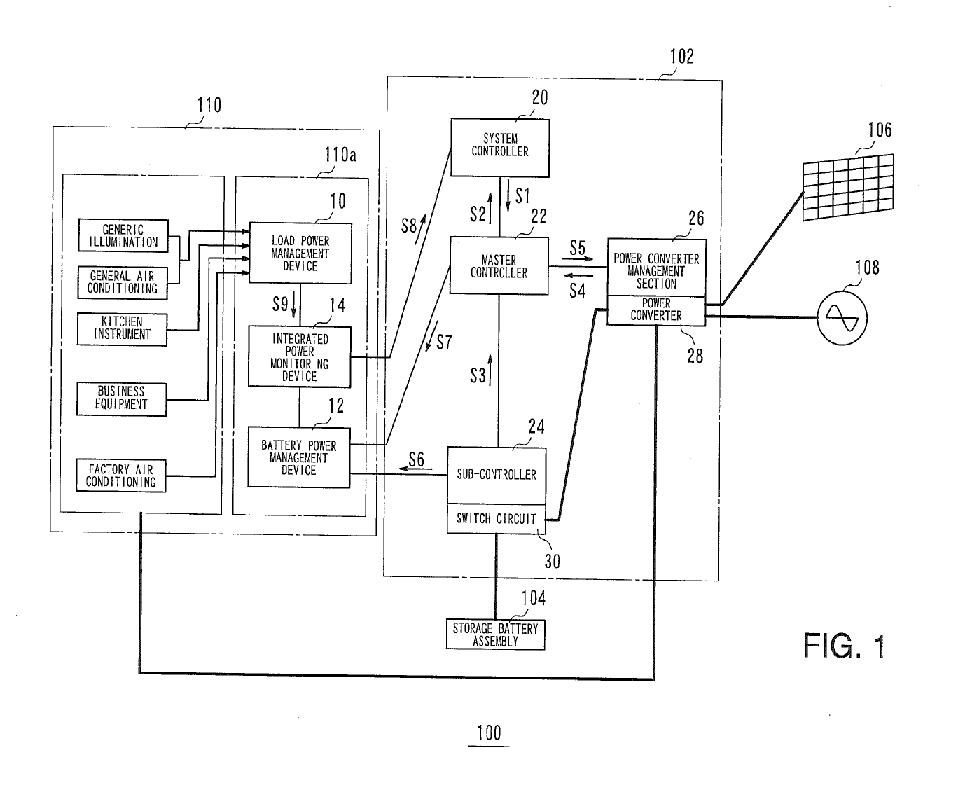

A power supply system 100 in an embodiment according to the present invention, as shown in FIG. 1, includes a power supply management system 102, a storage battery assembly 104, a solar cell system 106 and a power line 108. The power supply system 100 is used to supply electric power to a load 110. It is noted that in FIG. 1, thick solid lines show flow of electric power, and thin solid lines show flow of signals.

In this embodiment, the solar cell system 106 and the power line 108 are an electric power source. The power line 108, which is a single phase or three phase power supply, or the like, may be supplied by an external electric power company which combines electric power generated using various methods, such as hydroelectric power generation, nuclear power generation and thermal power generation. Also, the solar cell system 106 may be a large-scale photovoltaic system having electric generating capability of, for example, 1 MW. However, it is not restricted to this and may include another electric power source, such as a fuel battery or a wind power generation system.

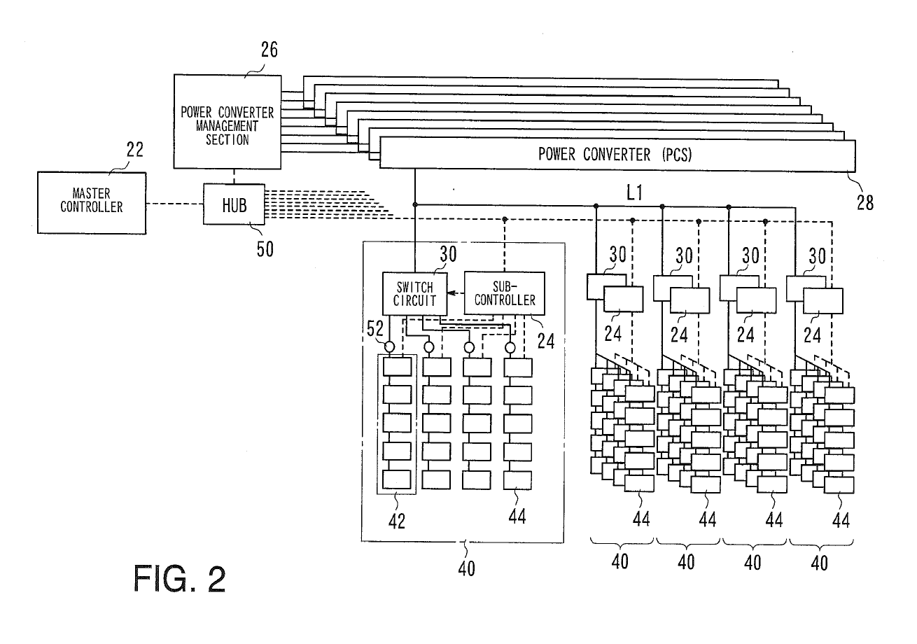

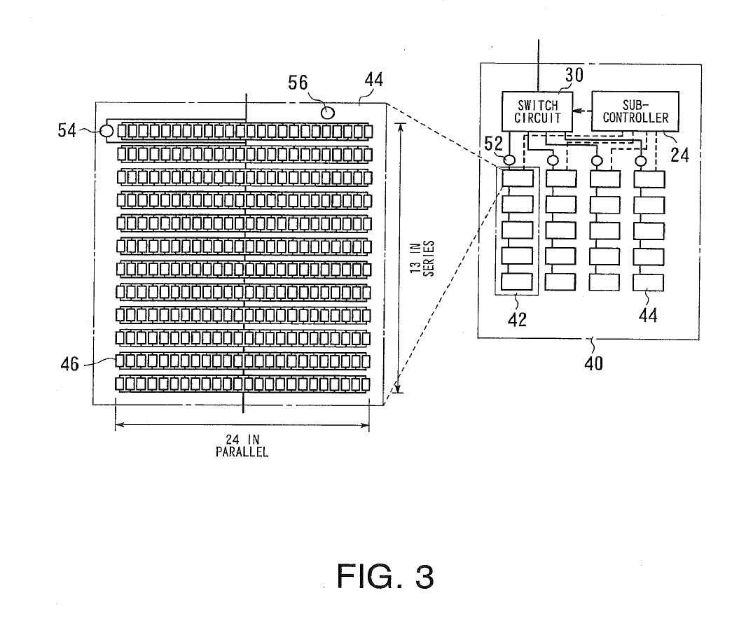

The storage battery assembly 104 is provided to supply electric power as a function of an amount of electric power required by the load 110. The storage battery assembly 104, as shown in FIGS. 2 and 3, is hierarchically configured so that a plurality of storage battery cells 46 is combined to form a storage battery pack 44, a plurality of the storage battery packs 44 is combined to form a storage battery pack group 42, and a plurality of the storage battery pack groups 42 are combined to form a storage battery unit 40.

In particular, the storage battery assembly 104 is configured as below. In this embodiment, as shown in FIG. 2, eight power converters 28 are provided, the storage battery assembly 104 is divided into eight portions, and to each of the portions, one power converter 28 is assigned to manage electric power. Each power converter 28 has five storage battery units 40 assigned thereto. That is, forty storage battery units 40 are provided in total, and each group of the five storage battery units 40 is connected to one power converter 28. It is noted that in FIG. 2, electric power lines are shown by solid lines, and signal lines by broken lines.

FIG. 3 shows one storage battery unit 40 extracted from FIG. 2 to illustrate its configuration in detail. One storage battery unit 40 is configured by connecting the storage battery pack groups (groups of storage battery packs) 42, that are connected in series as required, in parallel as required. In the example in FIG. 3, one storage battery pack group 42 is formed of five storage battery packs 44 connected in series, and one storage battery unit 40 is formed of four groups of the storage battery pack groups 42 connected in parallel. According to this embodiment, one storage battery unit 40 includes twenty storage battery packs 44.

Further, FIG. 3 shows an enlarged internal configuration of one storage battery pack 44. In this embodiment, one storage battery pack 44 is configured so that twenty-four storage battery cells 46, which are a unit of a storage battery, are connected to each other in parallel to form one group, and thirteen groups are connected to each other in series. That is, each storage battery pack 44 includes 312 storage battery cells 46 (24×13=312).

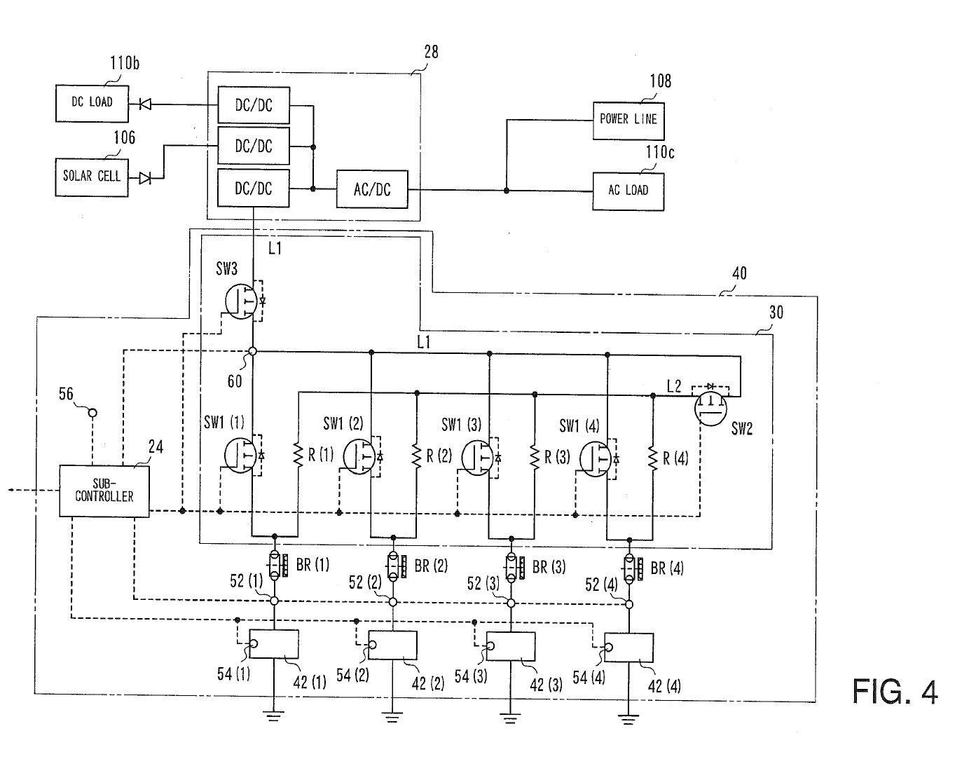

Each storage battery unit 40 includes a sub-controller 24 and a switch circuit 30. The switch circuit 30, as shown in FIG. 4, includes a selecting switch SW1 for each of the storage battery pack groups 42. Each of the storage battery pack groups 42 is connected to a parallel connection line L1 via the selecting switch SW1. The selecting switch SW1 is controlled to be opened or closed in response to an open/close signal from the sub-controller 24. That is, each of the storage battery pack groups 42 is the smallest unit to control when the storage batteries are connected to the parallel connection line L1.

Also, as shown in FIG. 4, the storage battery pack groups 42 (42 (1)-42 (4)) included in each of the storage battery units 40 are connected to a charging or discharging line L2 via resistors R (R (1)-R (4)), respectively. Consequently, charging or discharging currents flow mutually to or from the storage battery pack groups 42 (42 (1)-42 (4)) via the resistors R (R (1)-R (4)), and charging states of the storage battery pack groups 42 (42 (1)-42 (4)) are thus equalized. Preferably, the resistors R (R (1)-R (4)) have a value by which electric currents so large as to adversely affect are prevented from flowing to or from the storage battery pack groups 42 (42 (1)-42 (4)). For example, if an output voltage of the storage battery pack group 42 is within a range from about 200 volts to 250 volts, the resistor R is preferably set to have a value from a few dozen ohms to hundreds of ohms. Further, for charging or discharging of the storage battery pack groups 42 (42 (1)-42 (4)) via the parallel connection line L1 and the charging or discharging line L2, a switch SW2 may be provided.

For each of the storage battery pack groups 42 in the storage battery unit 40, a current sensor 52 is provided to detect an electric current of each storage battery pack group 42. Also, for each of thirteen parallel assemblies of the storage battery cells 46 connected in series in each of the storage battery packs 44, a voltage sensor 54 is provided. The voltage sensor 54 detects a voltage across terminals of the parallel assembly of the storage battery cells 46, as a cell voltage. It is noted that FIG. 3 shows only one voltage sensor 54 for simplicity. Also, a temperature of the storage battery pack 44 is detected as a pack temperature by a temperature sensor 56. It is noted that a plurality of the temperature sensors 56 may be provided for each of the storage battery packs 44. These data is acquired by the sub-controller 24. The sub-controller 24 outputs these data and a state of charge (SOC) derived from these data to a master controller 22 and a battery power management device 12, as unit state data S3 and S6 representative of a state of each storage battery unit 40. Also, if there is a failure in any storage battery unit 40 constituting the storage battery assembly 104, the sub-controller 24 sends data for identifying which storage battery unit 40 has the failure, by including the data in the unit state data S3 and S6.

It is noted that numbers by which the storage battery cell 46, the storage battery pack 44, the storage battery pack group 42 and the storage battery unit 40 are combined, respectively, may be properly selected depending on specifications of the power supply system 100. Also, a lithium ion cell may be used as the storage battery, but besides this, any secondary battery may be also used. For example, a nickel-hydrogen cell, a nickel-cadmium cell, a manganese cell and the like may be used.

The power supply system 100 is provided to supply electric power to the load 110, including generic illumination, general air conditioning, kitchen instruments, display cases, and air conditioning facilities for factory facilities.

For the load 110, a power management system 110a is provided. The power management system 110a includes a load power management device 10, the battery power management device 12 and an integrated power monitoring device 14.

The load power management device 10 acquires information data on the load side S9 representative of electric power required by the load 110. The information data on the load side S9 includes an amount of electric power required by the entire load 110 so that a system controller 20 mentioned below can set an entire charging or discharging control command S1. As shown in FIG. 1, when the load 110 is divided into four systems, the load power management device 10 is an assembly having four systems of load power management devices therein. The load power management device 10 transfers the information data on the load side S9 to the integrated power monitoring device 14.

The battery power management device 12 receives unit state data S6 representative of a state of each storage battery unit 40 included in the storage battery assembly 104, and power converter management data S7 representative of a state of each power converter 28 included in the power supply system 100. The battery power management device 12 transfers these items of information to the integrated power monitoring device 14. The unit state data S6 includes information used for creation of the entire charging or discharging control command S1. The unit state data S6 includes, as described above, data about such values as voltage, temperature, electric current, SOC and the like of the storage battery constructing the storage battery assembly, and information representative of a failure if the failure arises in any of the storage battery units 40 constituting the storage battery assembly 104. Also, the power converter management data S7 includes information about a failure of the power converter 28 associated with setting of the entire charging or discharging control command S1. For example, if there is a failure, such as a malfunction, in any of the power converters 28, the power converter management data S7 includes information needed for identifying which power converter 28 has the failure.

The integrated power monitoring device 14 receives the information data on the load side S9 from the load power management device 10, and the unit state data S6 and the power converter management data S7 from the battery power management device 12, and extracts data needed for charging or discharging control from these data. The integrated power monitoring device 14 outputs the extracted information to the system controller 20, as a system management signal S8. The system management signal S8 is sent, for example, every second.

The power supply management system 102, as shown in FIG. 1, includes the system controller 20, the master controller 22, the sub-controller 24, a power converter management section 26, the power converter 28 and the switch circuit 30. The power supply management system 102 is configured as a hierarchical control system, and its control function is carried out by the system controller 20 at the top, the master controller 22 under the system controller 20, the power converter management section 26 under the master controller 22 and the sub-controller 24 independent of the master controller 22, depending on a hierarchical sequence from above.

The system controller 20 has an integrated power management function for the power supply system 100. The master controller 22 is a control device that receives the entire charging or discharging control command S1 from the system controller 20, and totally and comprehensively performs charging or discharging control for the storage battery assembly 104. The power converter management section 26 controls processing for functions such as power conversion, voltage conversion and the like in each of the power converters 28 included in the power supply system 100. The sub-controller 24 is provided for each of the storage battery units 40 included in the storage battery assembly 104, and controls charging or discharging in each storage battery unit 40. These components will be described below.

The system controller 20 receives a system management signal S8 including load information data S9, battery information signal S6 and power converter management data S7 from the power management system 110a, and based on these information creates and outputs the entire charging or discharging control command S1, which is a charging or discharging control command, to the entire power supply system 100.

In particular, the system controller 20 considers states of the storage battery units 40 and the power converters 28 to find out a charging or discharging condition for satisfying a required amount of electric power for the entire load 110, based on charging or discharging capacity of the storage battery assembly 104, and then sends the charging or discharging condition to the master controller 22, as the entire charging or discharging control command S1. Further, preferably, the system controller 20 also considers information about charging or discharging capacity of the storage battery units 40 connected to the power converter 28 which has a failure, and information about charging or discharging of the storage battery unit 40 which has a failure, and then finds out a charging or discharging condition for satisfying a required amount of electric power for the entire load 110, based on the charging or discharging capacity of the storage battery assembly 104, and subsequently sends this to the master controller 22, as the entire charging or discharging control command S1.

The entire charging or discharging control command S1 shows the charging or discharging condition by an amount of electric power and an amount of time, for example, “charging carried out at XX kW for YY seconds”. In addition to this, a charging upper limit voltage may be specified, for example, “charging carried out at XX kW until a voltage reaches ZZ volts”, a discharging lower limit voltage may be specified, for example, “discharging carried out to ZZ volts”, or charging or discharging may be instructed by specifying SOC. The term “SOC” here means that SOC (state of charge) in which electric power is stored to the maximum is set as 100, the reference, and SOC in which an amount of electric power is stored is expressed as a percentage relative to the reference.

The entire charging or discharging control command S1 is sent irregularly only when required, and accordingly may not be sent for a considerably long time period as the case may be. In such a case, the master controller 22 which is to receive the entire charging or discharging control command S1 may not determine the system controller 20 does not send the command S1 whether because of a lack of necessity or a failure of the system controller 20. Thus, a confirmation signal S2 for confirming whether the system controller 20 is normal or not is sent to the system controller 20 by the master controller 22 at proper intervals. The system controller 20 responds by sending a response signal if normal. When the master controller 22 receives the response signal from the system controller 20, it can determine that the system controller 20 is normal, and when it does not receive the response signal from the system controller 20, it can determine that the system controller 20 has a failure. The proper interval may be, for example, 10 minutes. If the system controller 20 is determined to have a failure, processing, such as notifying a user of that fact, may be conducted.

The master controller 22 is a control device having functions to receive the entire charging or discharging control command S1 from the system controller 20, and send, to the power converter management section 26, an assembly charging or discharging control command S5 to each of the power converters 28.

Also, the master controller 22 receives power converter management data S4, state data about each power converter 28 from the power converter management section 26, and unit state data S3 showing a state of each storage battery unit 40 from the sub-controller 24 provided in each storage battery unit 40 included in the storage battery assembly 104, determines whether the entire charging or discharging control command S1 sent by the system controller 20 can be executed without any change or not, based on the power converter management data S4 and the unit state data S3, and then, based on the determination result, sends the assembly charging or discharging control command S5 to the power converter management section 26. The determination can be conducted by applying the unit state data S3 and the like to a predefined conditional equation. The assembly charging or discharging control command S5 is received and sent at intervals of 100 milliseconds, and the power converter management data S4 and the unit state data S3 are received and sent at intervals of, for example, 1 second.

The entire charging or discharging control command S1 is a command value that is sent to the master controller 22 and shows an amount of charging or discharging power of the entire storage battery assembly 104, and the assembly charging or discharging control command S5 is a command value into which the command value of the entire charging or discharging control command S1 is resolved to be assigned to each power converter 28. As shown in FIG. 2, if eight power converters 28 are provided for the power converter management section 26, and the entire charging or discharging control command S1 has a command content, “discharging performed at 320 kW for 1,800 seconds”, then the assembly charging or discharging control command S5 will have a command content, “a first power converter 28 discharges at 40 kW, a second power converter 28 discharges at 40 kW, . . . , and an eighth power converter 28 discharges at 40 kW”. It is noted that in this particular example, an individual command value of the assembly charging or discharging control command S5 is a value calculated by evenly dividing the command value of the entire charging or discharging control command S1 by the number of power converters 28, but it may be an individual value other than this value. For example, when the fact that any of the power converters 28 controlled by the power converter management section 26 has a failure is sent through the power converter management data S4, then an assembly charging or discharging control command S5 having a command content in which an amount of charging or discharging power of the entire charging or discharging control command S1 is partially restricted is sent to the power converter management section 26. In particular, the power converter management data S4 includes information representative of a failure present in the power converter 28, the unit state data S3 includes information representative of a failure present in the storage battery unit 40, and the master controller 22 accordingly creates an assembly charging or discharging control command S5 for other power converters 28 excluding the power converter 28 having the failure, so that a charging or discharging state required by the entire charging or discharging control command S1 can be satisfied by other storage battery units excluding the storage battery unit 40 having the failure among the storage battery units 40 connected to the power converter 28 having the failure, and sends it to the power converter management section 26.

Further, the master controller 22 sends, as the power converter management data S7, data having the same content as that of the power converter management data S4 received from the power converter management section 26 to the battery power management device 12. The power converter management data S7 may be sent at longer intervals than the power converter management data S4. For example, if the power converter management data S4 is sent at intervals of 1 second, the power converter management data S7 may be sent at intervals of 10 seconds. In this case, the power converter management data S7 includes information having a total of the power converter management data S4 created ten times during the time period for the power converter management data S7. Of course, the power converter management data S7 may be sent at different intervals, and it may be sent at the same intervals as those of the power converter management data S4.

The sub-controller 24, as described above, is provided for each of the storage battery units 40, and controls to open and close a switch included in the switch circuit 30 provided for each of the storage battery units 40, depending on a state of each storage battery unit 40. When a driving power supply of the storage battery unit 40 (not shown) is turned on, and a charging or discharging condition is satisfied, then the sub-controller 24 closes a unit switch SW3 in the switch circuit 30 shown in FIG. 4, and connects the storage battery unit 40 to the power converter 28.

Here, the sub-controller 24 determines a state of the storage battery unit 40, based on an electric current value detected by the current sensor 52 and a voltage value detected by the voltage sensor 54 provided for each of the storage battery pack groups 42, and a temperature detected by the temperature sensor 56 provided for each of the storage battery units 40, and then, if there is a failure in a state of the storage battery unit 40, the sub-controller 24 opens the unit switch SW3 in the switch circuit 30 and disconnects this storage battery unit 40 from the power converter 28.

Further, the sub-controller 24 determines a state of the storage battery pack 44 and a state of the storage battery pack group 42, based on an electric current value detected by the current sensor 52 and a voltage value detected by the voltage sensor 54 provided for each of the storage battery pack groups 42, a temperature detected by the temperature sensor 56 provided for each of the storage battery units 40, and a reference voltage detected by a voltage sensor 60 provided in the parallel connection line L1, and then, depending on the determination result, controls to open and close the switches SW1 (SW1 (1)-SW1 (4)) corresponding to the storage battery pack groups 42.

For example, if the sub-controller 24 determines a failure in the state of the storage battery pack and/or the state of the storage battery pack group 42, based on the electric current value detected by the current sensor 52 and the voltage value detected by the voltage sensor 54 provided for each storage battery pack group 42, the temperature detected by the temperature sensor 56 provided for each storage battery unit 40, and the reference voltage detected by the voltage sensor 60 provided in the parallel connection line L1, it then disconnects the storage battery pack group 42 including the storage battery pack 44 having the failure from the parallel connection line L1. In particular, the sub-controller 24 opens the switch SW1 (SW1 (1)-SW1 (4)) corresponding to this storage battery pack group 42 including the storage battery pack 44 having the failure. Further, the sub-controller 24 sends information representative of the failure in the storage battery pack 44 and/or the storage battery pack group 42 to the master controller 22 and the battery power management device 12, as the unit state data S3 and S6.

The failure can be determined by comparison with a predefined condition, such as whether the electric current detected by the current sensor 52 exceeds a threshold value derived from a predefined conditional equation, whether the cell voltage detected by the voltage sensor 54 exceeds a predefined threshold value range, and whether the pack temperature detected by the temperature sensor 56 exceeds a predefined threshold value.

Further, when the storage battery assembly 104 begins to charge or discharge, the switches SW1 (SW1 (1)-SW1 (4)) corresponding to the storage battery pack groups 42 are controlled to be opened or closed, based on a voltage value detected by the voltage sensor 54 provided for each storage battery pack group 42. This processing will be described below.

In addition, the sub-controller 24, as described above, sends information representative of a failure in the storage battery unit 40 to the master controller 22 and the battery power management device 12, as the unit state data S3 and S6. The sub-controller 24 sends, to the battery power management device 12, data having the same content as that of the unit state data S3 sent to the master controller 22, as the unit state data S6. Here, the unit state data S6 may be sent at longer intervals than the unit state data 56. For example, if the unit state data S3 is sent every second, the unit state data S6 may be sent at intervals of 10 seconds. In this case, the unit state data S6 includes information having a total of the unit state data S3 created ten times during the time period for the unit state data S6. Of course, the unit state data S6 may be sent at different intervals, or it may be sent at the same intervals as those of the unit state data S3.

The power converter management section 26 receives the assembly charging or discharging control command S5 from the master controller 22, and controls each of the power converters 28 to be controlled. In the power supply system 100 in this embodiment, as shown in FIG. 2, there are eight power converters 28 to be controlled by the power converter management section 26. However, the number of the power converters 28 is not restricted to this, and may be appropriately changed.

Each of the power converters 28, as shown in FIG. 4, has functions, such as DC to AC conversion between AC power of the power line 108 and AC load 110c and DC power of the storage battery assembly 104, voltage conversion between DC power of the solar cell system 106 and the DC power of the storage battery assembly 104, power conversion between the DC power of the storage battery assembly 104 and DC power of DC load 110b, and voltage conversion between the DC power of the storage battery assembly 104 and the DC power of the DC load 110b. In particular, the power converter 28 includes a bidirectional DC/AC conversion circuit, a bidirectional voltage conversion circuit and the like, as the need arises. The power converter management section 26, according to the assembly charging or discharging control command S5, controls DC/AC conversion and voltage conversion in each power converter 28 when the solar cell system 106 and/or the power line 108 charge the storage battery assembly 104, and when the storage battery assembly 104 discharges to supply electricity to the load 110. Further, when there is a failure in any of the power converters 28 under control of the power converter management section 26, or when the master controller 22 sends a suppression command of charging or discharging, or a standby command, then the power converter management section 26 brings the power converter 28 having this failure into a standby state, and sends information representative of the failure in the power converter 28 to the master controller 22, as the power converter management data S4.

For example, eight power converters 28, as shown in FIG. 2, are provided, and if the assembly charging or discharging control command S5 has a content of “the first power converter 28 discharges at 40 kW, the second power converter 28 discharges at 40 kW, . . . , and the eighth power converter 28 discharges at 40 kW”, then the power converter management section 26 controls voltage conversion and power conversion carried out in each power converter 28 so that each power converter 28 supplies electric power to the load 110 at 40 kW, respectively. Further, if the assembly charging or discharging control command S5 has a content of “the first power converter 28 charges at 40 kW, the second power converter 28 charges at 40 kW, . . . , and the eighth power converter 28 charges at 40 kW”, then the power converter management section 26 controls the voltage conversion and power conversion carried out in each power converter 28 so that the solar cell system 106 and/or the power line 108 charge at 40 kW, respectively, through each power converter 28.

As described above, the system controller 20 determines a charging or discharging condition for the entire storage battery assembly 104, depending on a required amount of power for the entire load 110, and sets it as the entire charging or discharging control command S1. Then, the master controller 22, so as to satisfy a charging or discharging control command specified by the entire charging or discharging control command S1, creates the assembly charging or discharging control command S5 to particularly control each power converter 28 by considering a failure arising in the power converter 28 and/or the storage battery unit 40, and controls each power converter 28 by using the power converter management section 26 under the master controller 22. In doing so, the power converter management section 26 disconnects the power converter 28 and the storage battery unit 40 connected thereto, independently of control by the system controller 20 and the master controller 22 which are on a higher level. Also, the sub-controller 24 controls to connect or disconnect the storage battery pack groups 42 included in each storage battery unit 40, independently of control by the system controller 20 and the master controller 22 which are on a higher level. In this way, even if there is a failure in the power converter 28 and/or the storage battery unit 40, the storage battery assembly 104 can be handled by such a hierarchical control as if it was one storage battery, seen from the system controller 20. Further, consequently, the processing load in the control system of a higher level can be reduced, and the system configuration can be flexibly changed.

When, in the power supply system 100, a plurality of the storage battery pack groups 42 are connected in parallel to charge or discharge, the power supply system 100 is configured to prevent large charging or discharging current from flowing among the storage battery pack groups 42 due to output voltage differences among the storage battery pack groups 42.

### <On Discharging>

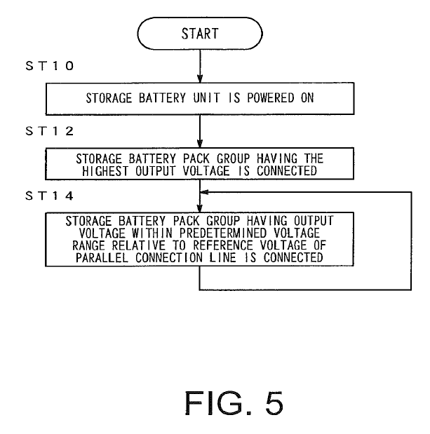

Processing for discharging the storage battery assembly 104 to supply electricity to the load 110 will be described. The processing on discharging is carried out according to a flowchart shown in FIG. 5. In the following description, it is assumed that initially, all of the storage battery units 40 included in the storage battery assembly 104 are powered off, and a selecting switch SW1, a switch SW2, and the unit switch SW3 included in each storage battery unit 40 are opened. Also, in the following description, the output voltage of the storage battery pack group 42 detected by the voltage sensor 54 means the sum of values detected by the voltage sensor 54 provided in each parallel assembly of the storage battery cells 46 included in the storage battery pack group 42.

At step ST10, any one of the storage battery units 40 assigned to each power converter 28 is powered on. The sub-controller 24 whose storage battery unit 40 is powered on closes the unit switch SW3 included in that storage battery unit 40, and connects it to the power converter 28. Thereby, one storage battery unit is connected to each power converter 28.

Here, the storage battery units 40 may be manually powered on by a user, or each storage battery unit 40 may be automatically powered on by the master controller 22 or the like in order according to a predetermined sequence. However, preferably, other storage battery units 40 are powered on in order after Step ST12 in the following processing is completed for each of the storage battery units 40 already powered on.

At Step ST12, the storage battery pack group 42 having the highest output voltage is selected from the storage battery pack groups 42 included in the storage battery units 40 powered on at Step ST10, and the selecting switch SW1 corresponding to the selected storage battery pack group 42 is closed. This processing is carried out for each of the power converters 28.

For example, in the case of a configuration shown in FIG. 4, the sub-controller 24 acquires voltage values detected by the voltage sensors 54 (1)-54 (4) provided in the storage battery pack groups 42 (1)-42 (4), and obtains an output voltage of each of the storage battery pack groups 42 (1)-42 (4). If the storage battery pack group 42 (1) has the highest output voltage of the output voltages of the storage battery pack groups 42 (1)-42 (4), the sub-controller 24 closes the selecting switch SW1 (1) corresponding to the storage battery pack group 42 (1), and connects it to the parallel connection line L1. Thus, the parallel connection line L1 has a reference voltage depending on the output voltage of the storage battery pack group 42 (1) first connected thereto.

At Step ST14, the selecting switches SW1 corresponding to the storage battery pack groups 42 are controlled to be opened or closed based on output voltage differences among the storage battery pack groups 42 included in the storage battery unit 40 powered on.

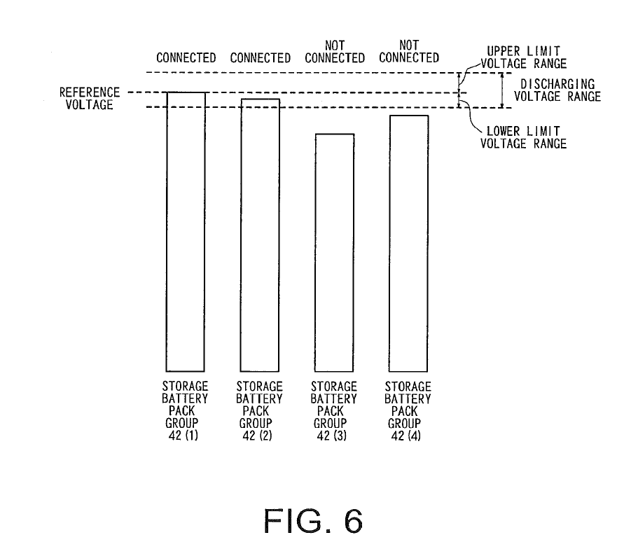

If the selecting switch SW1 (1) corresponding to the storage battery pack group 42 (1) is closed at Step ST12, the sub-controller 24 determines whether differences between the output voltages detected by the voltage sensors 54 (2)-54 (4) provided in the storage battery pack groups 42 (2)-42 (4) and the output voltage detected by the voltage sensor 54 (1) in the storage battery pack group 42 (1) already connected to the parallel connection line L1 are within a predefined voltage range during discharging or not. Then, the sub-controller 24, as shown in FIG. 6, closes only the selecting switch SW1 (2) corresponding to the storage battery pack group 42 (2) having an output voltage within the voltage range during discharging, and connects it to the parallel connection line L1. The voltage range during discharging is preferably set to have a value so as not to adversely largely affect the storage battery pack groups 42 due to electric current flowing among the storage battery pack groups 42 when a plurality of the storage battery pack groups 42 are connected to the parallel connection line L1.

For example, if the voltage range during discharging is +/−5 volts, and if only the storage battery pack group 42 (2) has the output voltage within a voltage range from 5 volts below the output voltage of the storage battery pack group 42 (1) to 5 volts above it, then only the selecting switch SW1 (2) corresponding to the storage battery pack group 42 (2) is closed.

The processing at Step ST14 is carried out by the sub-controller 24 as needed while the storage battery assembly 104 discharges to supply electricity to the load 110. That is, the storage battery pack groups 42 connected to the parallel connection line L1 discharge, and if the output voltages of the storage battery pack groups 42 are lowered, the selecting switches SW1 corresponding to the storage battery pack groups 42 that newly enter the voltage range during discharging are closed as needed.

Further, the storage battery pack groups 42 (42 (1)-42 (4)) charge or discharge, respectively, via resistors R (R (1)-R (4)) included in the switch circuit 30. Thus, the output voltage differences among the storage battery pack groups 42 (42 (1)-42 (4)) are also lowered, and the selecting switches SW1 corresponding to the storage battery pack groups 42 that newly enter the voltage range during discharging are closed as needed.

In this way, only the storage battery pack groups 42 having the output voltage within the voltage range during discharging are connected in parallel, thereby allowing performance degradation due to charging or discharging of the storage battery pack groups 42 to be prevented. Also, at Step ST12, the storage battery pack group 42 having the highest output voltage is selected from the storage battery pack groups 42 included in the storage battery unit 40, and is first connected to the parallel connection line L1, thereby realizing connection of the storage battery pack groups 42 to the parallel connection line L1 in order from the storage battery pack group 42 having the best possible charging state, and at the same time, the storage battery pack groups 42 discharge and consequently lower their output voltages, thereby allowing other storage battery pack groups 42 to also be connected to the parallel connection line L1 in order.

Further, charging or discharging of the storage battery pack groups 42 can be controlled via the selecting switches SW1, thereby allowing power consumption in the selecting switches SW1 to be reduced, and degradation and/or malfunction of the selecting switches SW1 due to large electric current to be suppressed. Further, an electric current flowing in each selecting switch SW1 is monitored by using the current sensor 52, and if the electric current exceeds a predefined value, the sub-controller 24 may be configured to control to open the corresponding selecting switch SW1.

It is noted that in the processing on discharging described above, the unit switch SW3 of an arbitrary storage battery unit 40 is closed and it is connected to the parallel connection line L1 at Step ST10, but the storage battery unit 40 including the storage battery pack group 42 having the highest output voltage may be selected from all of the storage battery pack groups 42 assigned to one power converter 28, and be first connected to the power converter 28.

In this case, the system is configured so that output voltage values of the storage battery pack groups 42 included in each storage battery unit 40 can be included in the unit state data S3 to be output to the master controller 22 through the sub-controller 24.

The master controller 22 identifies the storage battery unit 40 including the storage battery pack group 42 having the highest output voltage of the output voltages of all of the storage battery pack groups 42 assigned to each power converter 28, and first powers on that storage battery unit 40. In this case, preferably, the master controller 22 is configured so that it can control to power on and off the power converters 28 through the power converter management section 26. Subsequent processing is conducted similarly to Steps ST10-ST14 described above.

Thus, the storage battery pack group 42 having the highest output voltage of the output voltages of all of the storage battery pack groups 42 assigned to one power converter 28 can be first connected to the parallel connection line L1. Accordingly, in order from the storage battery pack group 42 having the best charging state among all of the storage battery pack groups 42 assigned to one power converter 28, the storage battery pack groups 42 can be connected to the parallel connection line L1, and at the same time, the storage battery pack groups 42 lower their output voltages due to discharging, thereby allowing other storage battery pack groups 42 to be also connected to the parallel connection line L1 in order.

Also, as shown in FIG. 6, preferably, the voltage range during discharging is divided into an upper limit range above the reference voltage and a lower limit range below the reference voltage, and the upper limit range is different from that of the lower limit range.

Here, more preferably, the upper limit range is set to be larger than the lower limit range. For example, if the upper limit range is set to be from the reference voltage to 3 volts above it, the lower limit range is preferably set to be from the reference voltage to 2 volts below it.

A storage battery is generally of higher durability against excess discharge, where electric current flows out, than against excess charge, where electric current flows in. Also, even if the upper limit range in the voltage range during discharging is set wider than the lower limit range, only the storage battery pack groups 42 having a higher voltage than the reference voltage are connected to the parallel connection line L1 and these storage battery pack groups 42 merely discharge, and there is accordingly a small possibility that characteristics of the storage battery pack group 42 would be degraded.

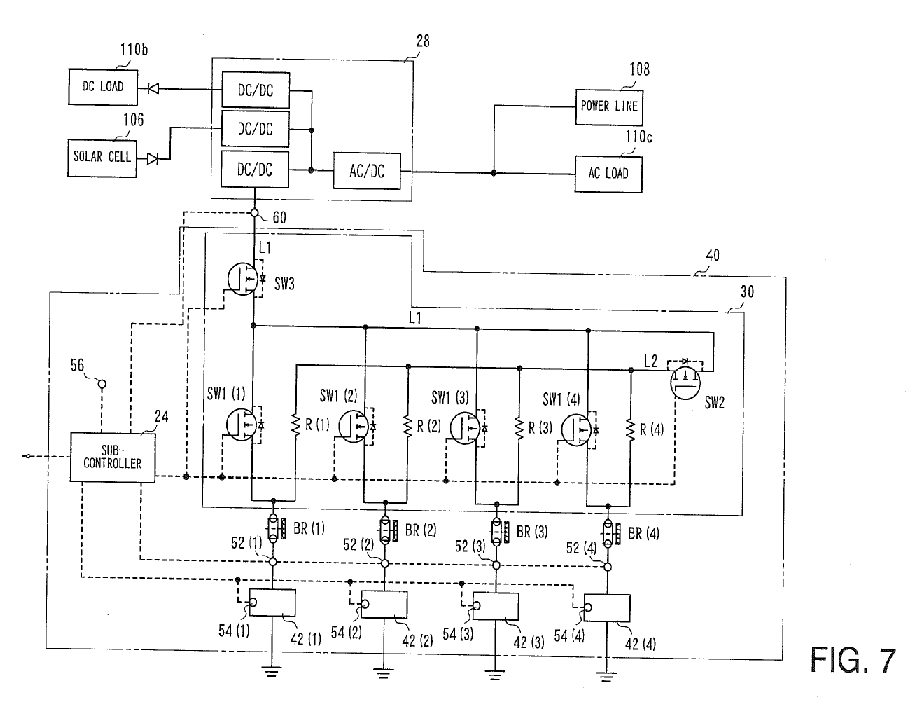

It is noted that the voltage sensor 60, as shown in FIG. 4, may be provided in each storage battery unit 40, or, as shown in FIG. 7, provided outside of the storage battery unit 40. In this case, the voltage sensor 60 may be commonly provided for a plurality of the storage battery units 40 connected to the same parallel connection line L1.

### <On Charging>

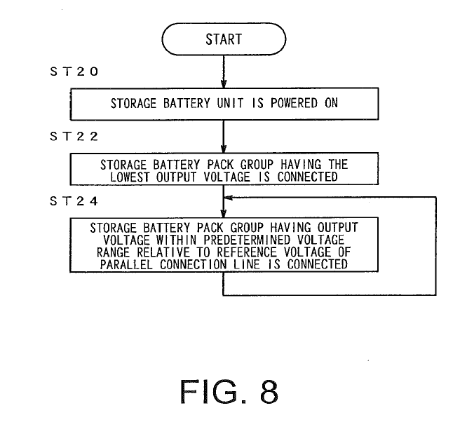

Processing for charging the storage battery assembly 104 by the solar cell system 106 and/or the power line 108 will be described below. Processing for charging is carried out according to a flowchart shown in FIG. 8. In the following description, initially, all of the storage battery units 40 included in the storage battery assembly 104 are powered off, and the selecting switches SW1, the switch SW2, and the unit switch SW3 included in each storage battery unit 40 are opened.

At Step ST20, any one of the storage battery units 40 assigned to each of the power converters 28 is powered on. The sub-controller 24 of the storage battery unit 40 powered on closes the unit switch SW3 included in that storage battery unit 40 and connects it to the power converter 28. Thus, one storage battery unit is connected to each power converter 28.

Here, the storage battery units 40 may be manually powered on by a user, or each storage battery unit 40 may be automatically powered on by the master controller 22 or the like, in order according to a predetermined sequence. However, preferably, other storage battery units 40 are powered on in order after Step ST22, and the following processing is completed for each storage battery unit 40 that is already powered on.

At Step ST22, the storage battery pack group 42 having the lowest output voltage is selected from the storage battery pack groups 42 included in the storage battery unit 40 powered on at Step S20, and the selecting switch SW1 corresponding to the extracted storage battery pack group 42 is closed. This processing is carried out for each of the power converters 28.

For example, in the case of a configuration shown in FIG. 4, the sub-controller 24 acquires voltage values detected by the voltage sensors 54 (1)-54 (4) provided in the storage battery pack groups 42 (1)-42 (4), and obtains an output voltage of each of the storage battery pack groups 42 (1)-42 (4). If the storage battery pack group 42 (1) has the lowest output voltage of the output voltages of the storage battery pack groups 42 (1)-42 (4), the sub-controller 24 closes the selecting switch SW1 (1) corresponding to the storage battery pack group 42 (1) and connects it to the parallel connection line L1. Thus, the parallel connection line L1 has a reference voltage depending on the output voltage of the storage battery pack group 42 (1) first connected thereto.

At Step ST24, the selecting switches SW1 corresponding to the storage battery pack groups 42 are controlled to be opened or closed depending on differences in output voltage among the storage battery pack groups 42 included in the storage battery unit 40 that is powered on.

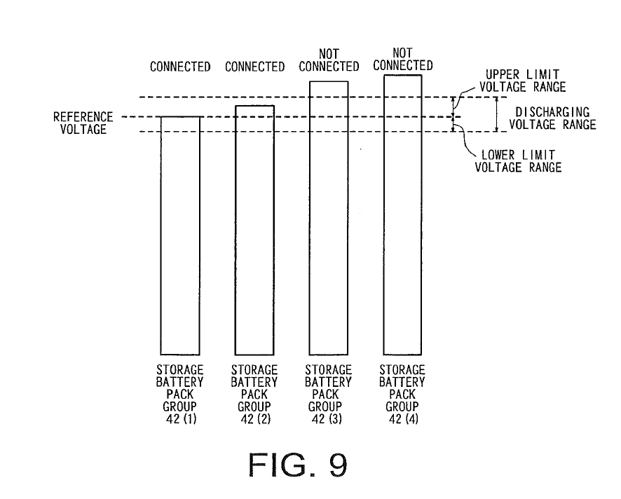

If the selecting switch SW1 (1) corresponding to the storage battery pack group 42 (1) is closed at Step ST22, the sub-controller 24 determines whether differences between the output voltages detected by the voltage sensors 54 (2)-54 (4) provided in the storage battery pack groups 42 (2)-42 (4) and the output voltage detected by the voltage sensor 54 (1) in the storage battery pack group 42 (1) already connected to the parallel connection line L1 are within a predefined voltage range during charging or not. Then, the sub-controller 24, as shown in FIG. 9, closes only the selecting switch SW1 (2) corresponding to the storage battery pack group 42 (2) which has a difference in voltage value within the voltage range during charging, and connects it to the parallel connection line L1. The voltage range during charging is preferably set to have a value so as not to adversely largely affect the storage battery pack groups 42 due to electric current flowing among the storage battery pack groups 42 if a plurality of the storage battery pack groups 42 are connected to the parallel connection line L1.

For example, if the voltage range during charging is +/−5 volts, and if only the storage battery pack group 42 (2) has the output voltage within a voltage range of 5 volts above and below the output voltage of the storage battery pack group 42 (1), then only the selecting switch SW1 (2) corresponding to the storage battery pack group 42 (2) is closed.

The processing at Step ST24 is carried out by the sub-controller 24 as needed while the storage battery assembly 104 charges. That is, the storage battery pack groups 42 connected to the parallel connection line L1 charge, and if the output voltages of the storage battery pack groups 42 are increased, the selecting switches SW1 corresponding to the storage battery pack groups 42 that newly enter the voltage range during charging are closed as needed.

Further, the storage battery pack groups 42 (42 (1)-42 (4)) charge or discharge, respectively, via resistors R (R (1)-R (4)) included in the switch circuit 30. Thereby, the differences in output voltage among the storage battery pack groups 42 (42 (1)-42 (4)) are also lowered, and the selecting switches SW1 corresponding to the storage battery pack groups 42 that newly enter the voltage range during charging are closed as needed.

In this way, only the storage battery pack groups 42 having the output voltage within the voltage range during charging are connected in parallel, thereby allowing performance degradation due to mutual charging or discharging of the storage battery pack groups 42 to be prevented. Also, at Step ST22, the storage battery pack group 42 having the lowest output voltage is selected from the storage battery pack groups 42 included in the storage battery unit 40, and is first connected to the parallel connection line L1, thereby allowing the storage battery pack groups 42 to be connected to the solar cell system 106 and/or the power line 108 in order from the storage battery pack group 42 having the poorest charged state, and at the same time, the storage battery pack groups 42 thus charge, and consequently their output voltages are increased, thereby allowing other storage battery pack groups 42 to also be connected to the parallel connection line L1 in order.

Further, charging or discharging of the storage battery pack groups 42 can be controlled via the selecting switches SW1, thereby allowing power consumption in the selecting switches SW1 to be reduced, and degradation and/or malfunction of the selecting switches SW1 due to large electric current to be suppressed. Further, an electric current flowing in each selecting switch SW1 is monitored by using the current sensor 52, and if the electric current exceeds a predefined value, the sub-controller 24 may be configured to control to open the corresponding selecting switch SW1.

It is noted that in the processing for charging described above, the unit switch SW3 of an arbitrary storage battery pack group 42 is closed and it is connected to the power converter 28 at Step ST20, but the storage battery unit 40 including the storage battery pack group 42 having the lowest output voltage may be selected from all of the storage battery pack groups 42 assigned to one power converter 28, and be first connected to the power converter 28.

In this case, the system is configured so that output voltage values of the storage battery pack groups 42 included in each storage battery unit 40 can be included in the unit state data S3 to be output to the master controller 22 through the sub-controller 24.

The master controller 22 identifies the storage battery unit 40 including the storage battery pack groups 42 having the lowest output voltage of the output voltages of all of the storage battery pack groups 42 assigned to each power converter 28, and first powers on this storage battery unit 40. In this case, preferably, the master controller 22 is configured so that it can control to power on or off the power converters 28 through the power converter management section 26. Subsequent processing is conducted similarly to Steps ST20-ST24 described above.

Thus, the storage battery pack group 42 having the lowest output voltage of the output voltages of all of the storage battery pack groups 42 assigned to one power converter 28 can be first connected to the parallel connection line L1. Accordingly, in order from the storage battery pack group 42 having the poorest charged state of all of the storage battery pack groups 42 assigned to one power converter 28, the storage battery pack groups 42 can be connected to the load 110, and at the same time, such a storage battery pack group 42 increases its output voltage due to charging, thereby allowing other storage battery pack groups 42 to also be connected to the parallel connection line L1 in order.

Also, as shown in FIG. 9, preferably, the voltage range during charging is divided into an upper limit range above the reference voltage and a lower limit range below the reference voltage, and the upper limit range is different from that of the lower limit range. The upper limit range of the voltage range during charging, similarly to the voltage range during discharging, is more preferably set to be larger than the lower limit range.

### Second Embodiment

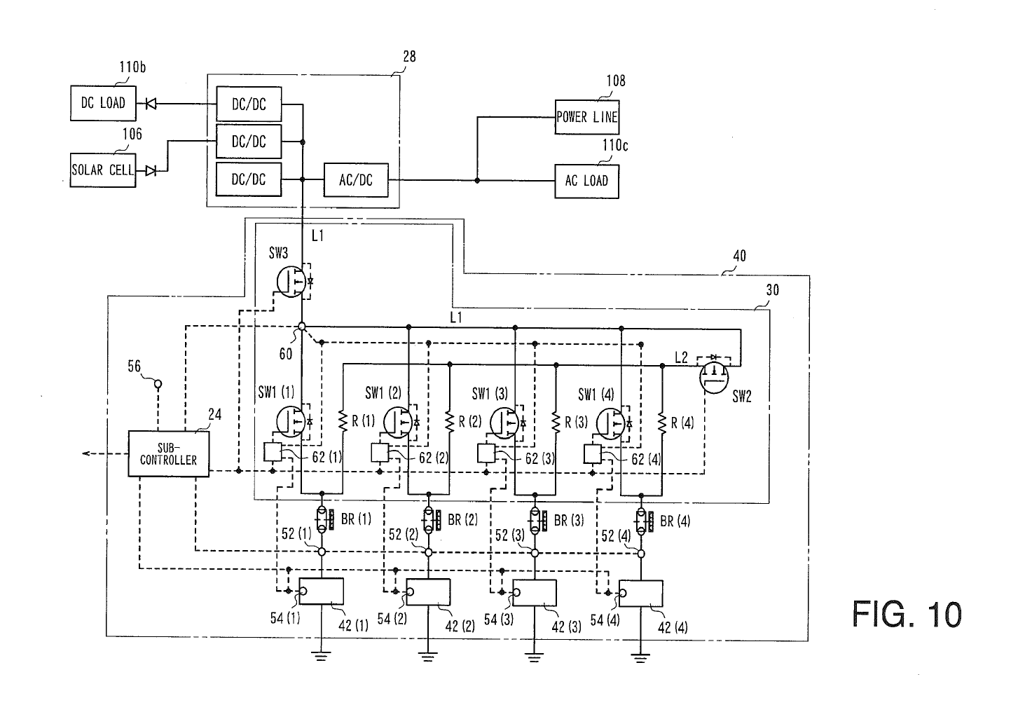

In a second embodiment, as shown in FIG. 10, a forced opening circuit 62 is provided in the switch circuit 30 included in each of the storage battery units 40. The forced opening circuit 62 is provided for each of the storage battery pack groups 42, and is a circuit for forcedly opening the selecting switch SW1 of the storage battery pack group 42, based on an output voltage of the storage battery pack group 42 and a reference voltage of the parallel connection line L1. If an opening/closing control signal is sent when the output voltage of the storage battery pack group 42 is not within the voltage range during discharging or the voltage range during charging, or if the output voltage is faultily detected in the sub-controller 22, then the forced opening circuit 62 is a circuit for forcedly disconnecting the storage battery pack group 42.

The forced opening circuit 62 (1) corresponding to the storage battery pack group 42 (1), as an example, will be described below. The forced opening circuit 62 (1) receives an output voltage of the storage battery pack group 42 (1) from the voltage sensor 54 (1) provided in the corresponding storage battery pack group 42 (1), and a reference voltage from the voltage sensor 60 provided in the parallel connection line L1. If a difference between the output voltage of the storage battery pack group 42 (1) and the reference voltage is within a predefined forced voltage range, the forced opening circuit 62 (1) sends, to the selecting switch SW1 (1), the opening/closing control signal output by the sub-controller 24 to the selecting switch SW1 (1), and if not within the forced voltage range, the forced opening circuit 62 (1) opens the selecting switch SW1 (1) ignoring the opening/closing control signal. However, preferably, the forced opening circuit 62 is controlled so as not to function until any of the storage battery pack groups 42 assigned to one power converter 28 is connected to the power converter 28.

Here, the forced voltage range is set to be a predefined voltage range relative to the reference voltage. If a plurality of the storage battery pack groups 42 are connected to the parallel connection line L1, the forced voltage range is preferably set to have a value so as not to adversely affect largely the storage battery pack groups 42 due to electric current flowing among the storage battery pack groups 42. The forced voltage range is, for example, set to be a range from 3 volts below the reference voltage to 3 volts above it.

By providing the forced opening circuit 62 in this way, even if the sub-controller 24 sends a control signal to close the selecting switch SW1, the selecting switch SW1 can be forcedly kept open when a difference between the output voltage of the storage battery pack group 42 and the reference voltage of the parallel connection line L1 is not within the forced voltage range.

The forced voltage range may be narrower than the voltage range during discharging and the voltage range during charging. For example, if the voltage range during discharging is set to be from 5 volts below the reference voltage to 5 volts above it, the forced voltage range can be set to be from 3 volts below the reference voltage to 3 volts above it. Also, for example, if the voltage range during charging is set to be from 5 volts below the reference voltage to 5 volts above it, the forced voltage range can be set to be from 3 volts below the reference voltage to 3 volts above it. Also, the forced voltage range may be wider than the voltage range during discharging and the voltage range during charging.

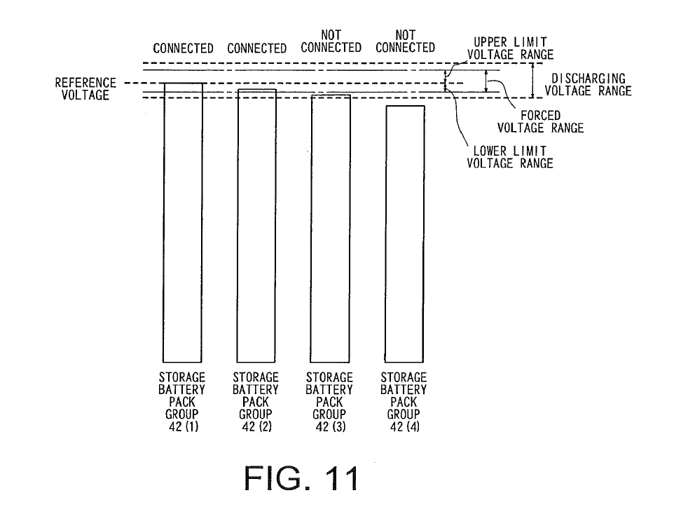

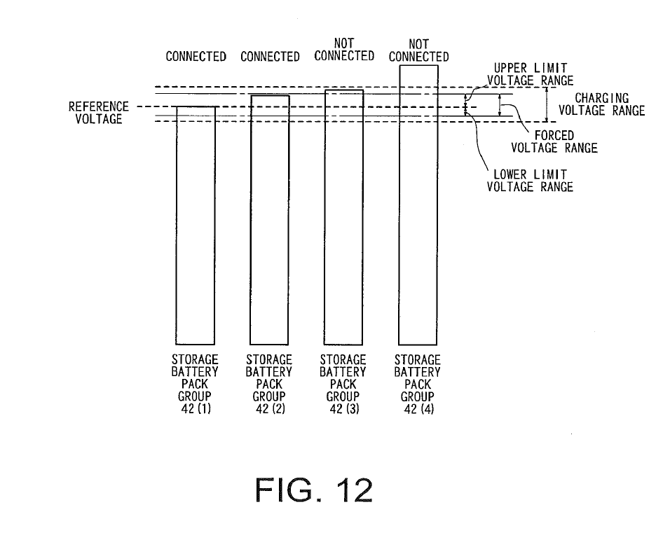

By setting the forced voltage range in this way, as shown in FIGS. 11 and 12, even if the sub-controller 24 issues the control signal to close the selecting switch SW1 of the storage battery pack group 42 whose output voltage enters the voltage range during discharging or the voltage range during charging, the selecting switch SW1 is forcedly kept open when the output voltage is not within the forced voltage range relative to the reference voltage of the parallel connection line L1. Accordingly, if the sub-controller 24 continues to output the control signal to close the selecting switch SW1, by the function of the forced opening circuit 62, the selecting switch SW1 can be automatically closed when the output voltage of the storage battery pack group 42 enters the forced voltage range. Accordingly, in a plurality of the storage battery units 40 commonly connected to the parallel connection line L1, the storage battery pack group 42 whose output voltage is not within the forced voltage range can be prevented from being connected in parallel. Accordingly, across a plurality of the storage battery units 40, excess charging or discharging of the storage battery pack groups 42 can be prevented.

It is noted that the voltage sensor 60, similarly to FIG. 7, may be provided outside of the storage battery unit 40. In this case, the voltage sensor 60 may be provided commonly for a plurality of the storage battery units 40 connected to the same parallel connection line L1. By providing the voltage sensor 60 outside of the storage battery unit 40 in this way, an effect of voltage drop due to wiring or a switch can be avoided, and the reference voltage can be set commonly for a plurality of the storage battery units 40 connected to each of the power converters 28.

Also, as shown in FIGS. 11 and 12, when the forced voltage range is divided into an upper limit range above the reference voltage and a lower limit range below the reference voltage, the upper limit range is also preferably different from that of the lower limit range.

Here, similarly to the voltage range during discharging and the voltage range during charging, more preferably, the upper limit range is set to be larger than the lower limit range. For example, if the upper limit range is preferably set to be from the reference voltage to 2 volts above it, the lower limit range is set to be from the reference voltage to 1 volt below it.

It is noted that if the forced opening circuit 62 in this embodiment is applied, in contrast to the first embodiment, the voltage range during discharging and the voltage range during charging may not be set. That is, the sub-controller 24 may output the control signal to close the selecting switch SW1 of the storage battery pack group 42 in order from the storage battery pack group 42 having the highest output voltage on discharging, and output the control signal to close the selecting switch SW1 of the storage battery pack group 42 in order from the storage battery pack group 42 having the lowest output voltage on charging. The forced opening circuit 62 may forcedly keep the selecting switch SW1 of the storage battery pack group 42 whose output voltage is not within the forced voltage range open, and close the selecting switch SW1 of the storage battery pack group 42 to connect it to the parallel connection line L1 when the output voltage enters the forced voltage range.

As described above, according to this embodiment, by connecting, to the parallel connection line L1, only the storage battery pack group 42 having an output voltage within the forced voltage range relative to the reference voltage of the parallel connection line L1, performance degradation due to excess mutual charging or discharging of the storage battery pack groups 42 can be prevented.

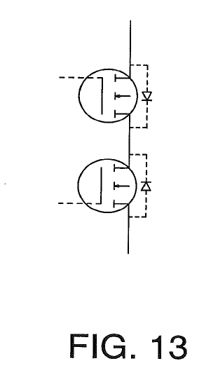

It is noted that in the embodiments described above, the selecting switch SW1, the switch SW2 and the unit switch SW3 are formed from a single FET, respectively, but as shown in FIG. 13, they are preferably replaced by a configuration including a plurality of FETs connected in series in the reverse direction because the single FET may produce a leakage current due to an effect of a parasitic diode. Thus, undesired charging or discharging due to the leakage current can be suppressed.

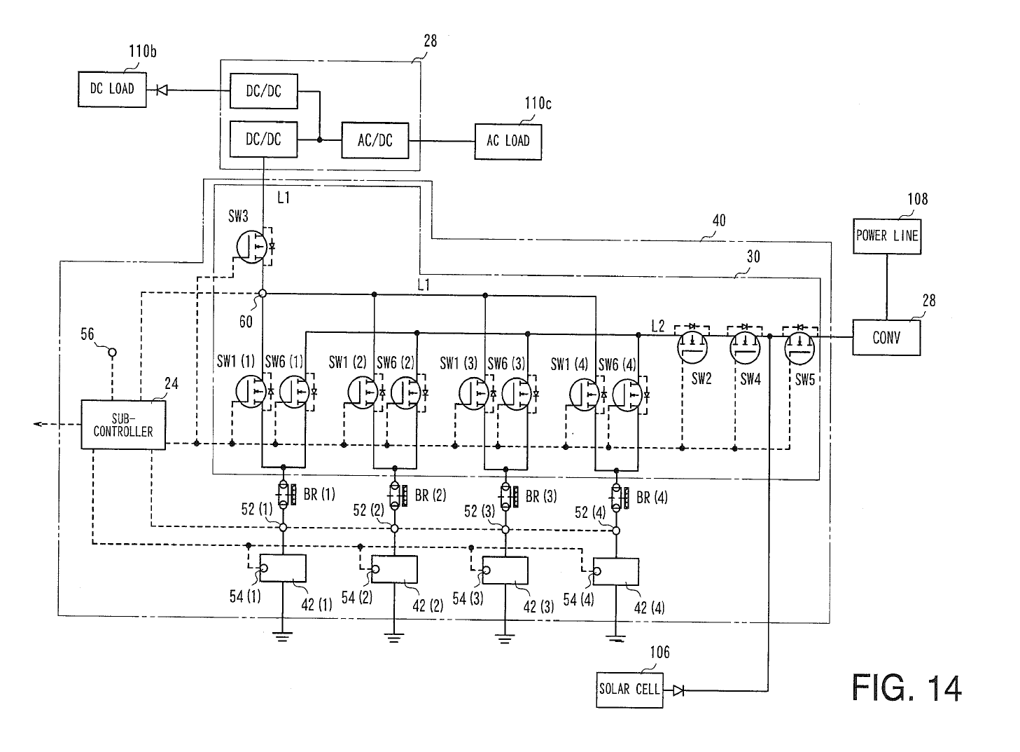

Also, as shown in FIG. 14, a discharging line L1 and a charging line L2 may be configured to be provided separately. Also, in this case, similarly to FIGS. 4, 7 and 10, control may be carried out depending on voltage among the storage battery pack groups 42, and control may be carried out where the forced opening circuit 62 for the selecting switch SW1 is provided.

1. A power supply system with a storage battery assembly including a plurality of storage battery pack groups connected to a parallel connection line via respective selecting switches, each storage battery pack group including at least one storage battery cell, wherein,
when electric power is supplied from at least one of the storage battery pack groups to a load connected to the parallel connection line, the storage battery pack group having the highest output voltage is selected from the storage battery pack groups included in the storage battery assembly and capable of being commonly connected to the parallel connection line, and is first connected to the parallel connection line, and
the highest output voltage of the output voltages of the storage battery pack groups connected to the parallel connection line is set as a reference voltage, and only the storage battery pack groups having an output voltage within a predetermined voltage range during discharging relative to the reference voltage are connected to the parallel connection line.

2. A power supply system including:
a storage battery assembly having a plurality of storage battery pack groups connected to a parallel connection line via respective selecting switches, each storage battery pack group including at least one storage battery cell, and
a power converter having a bidirectional DC/AC conversion circuit or a bidirectional voltage conversion circuit, and connected to a plurality of storage battery units included in the storage battery assembly via respective unit switches, wherein,
the storage battery pack group having the highest output voltage is selected from the storage battery pack groups included in the storage battery unit first connected to the power converter by closing the unit switch, and is first connected to the parallel connection line, and
the highest output voltage of the output voltages of the storage battery pack groups connected to the parallel connection line is set as a reference voltage, and only the storage battery pack groups having an output voltage within a predetermined voltage range during discharging relative to the reference voltage are connected to the parallel connection line.

3. The power supply system according to claim 1, wherein,
the voltage range during discharging includes a combination of an upper limit range from the reference voltage to above it and a lower limit range from the reference voltage to below it, and
the upper limit range is wider than the lower limit range.

4. A power supply system with a storage battery assembly including a plurality of storage battery pack groups connected to a parallel connection line via respective selecting switches, each storage battery pack group including at least one storage battery cell, wherein,
when at least one of the storage battery pack groups is charged through the parallel connection line, the storage battery pack group having the lowest output voltage is selected from the storage battery pack groups included in the storage battery assembly and capable of being commonly connected to the parallel connection line, and is first connected to the parallel connection line, and
the lowest output voltage of the output voltages of the storage battery pack groups connected to the parallel connection line is set as a reference voltage, and only the storage battery pack groups having an output voltage within a predetermined voltage range during charging relative to the reference voltage are connected to the parallel connection line.

5. A power supply system including:
a storage battery assembly having a plurality of storage battery pack groups connected to a parallel connection line via respective selecting switches, each storage battery pack group including at least one storage battery cell, and
a power converter having a bidirectional DC/AC conversion circuit or a bidirectional voltage conversion circuit, and connected to a plurality of storage battery units included in the storage battery assembly via respective unit switches, wherein,
the storage battery pack group having the lowest output voltage is selected from the storage battery pack groups included in the storage battery unit first connected to the power converter by closing the unit switch, and is first connected to the parallel connection line, and
the lowest output voltage of the output voltages of the storage battery pack groups connected to the parallel connection line is set as a reference voltage, and only the storage battery pack groups having an output voltage within a predetermined voltage range during charging relative to the reference voltage are connected to the parallel connection line.

6. The power supply system according to claim 4, wherein,
the voltage range during charging includes a combination of an upper limit range from the reference voltage to above it and a lower limit range from the reference voltage to below it, and
the upper limit range is wider than the lower limit range.

7. The power supply system according to claim 1, wherein,
after at least one of the storage battery pack groups is connected to the parallel connection line, the storage battery pack group having an output voltage out of a predetermined forced voltage range relative to the reference voltage of the parallel connection line, among the storage battery pack groups, is not connected to the parallel connection line.

8. The power supply system according to claim 2, wherein,
after at least one of the storage battery pack groups is connected to the parallel connection line, the storage battery pack group having an output voltage out of a predetermined forced voltage range relative to a reference voltage of the parallel connection line between the power converter and the unit switch, among the storage battery pack groups, is not connected to the parallel connection line.

9. The power supply system according to claim 1, wherein,
a control section for controlling to open or close the selecting switch is provided for each of the storage battery units.

10. The power supply system according to claim 1, further including:
a control section for outputting an open/close control signal to the selecting switch, and
a forced opening circuit for blocking the control signal output by the control section to the selecting switch of the storage battery pack group whose output voltage is out of the voltage range relative to a voltage of the parallel connection line.

11. The power supply system according to claim 4, wherein,
after at least one of the storage battery pack groups is connected to the parallel connection line, the storage battery pack group having an output voltage out of a predetermined forced voltage range relative to the reference voltage of the parallel connection line, among the storage battery pack groups, is not connected to the parallel connection line.

12. The power supply system according to claim 4, wherein,
a control section for controlling to open or close the selecting switch is provided for each of the storage battery units.

13. The power supply system according to claim 4, further including:
a control section for outputting an open/close control signal to the selecting switch, and
a forced opening circuit for blocking the control signal output by the control section to the selecting switch of the storage battery pack group whose output voltage is out of the voltage range relative to a voltage of the parallel connection line.

14. The power supply system according to claim 5, wherein,
after at least one of the storage battery pack groups is connected to the parallel connection line, the storage battery pack group having an output voltage out of a predetermined forced voltage range relative to a reference voltage of the parallel connection line between the power converter and the unit switch, among the storage battery pack groups, is not connected to the parallel connection line.
